(19) United States
(12) Patent Application Publication
(10) Pub. No.: US 2008/0115127 A1
(43) Pub. Date: May 15, 2008

(54) APPARATUS AND METHOD FOR CARRYING OUT INFORMATION PROCESSING BY VIRTUALIZATION

(75) Inventors: Yuichi Hatano, Hamura-shi (JP); Haruo Tomita, Iruma-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/939,193

(22) Filed: Nov. 13, 2007

(30) Foreign Application Priority Data
Nov. 13, 2006 (JP) 2006-307259

(51) Int. Cl. G06F 9/455

(52) U.S. Cl. 718/1

(57) ABSTRACT

According to one embodiment, a virtual processing portion, which has a work processing portion that issues a request for process using a hardware resource and which operates as a virtual computer, includes a hardware resource managing portion having a manager that collectively manages hardware resources of respective information processing apparatuses connected to the network and that is configured to transmit the request for process to one of the information processing apparatuses capable of performing the process in accordance with the request and to acquire a result of process. A second virtual process monitoring portion is configured to receive the request issued from the work processing portion, transfer the request to the hardware resource managing portion if the request satisfies a certain condition, receive the result of process corresponding to the request from the hardware resource managing portion and transfer the result of process to the work processing portion.

### CROSS-REFERENCE TO RELATED APPLICATIONS

This application is based upon and claims the benefit of priority from Japanese Patent Application No. 2006-307259, filed Nov. 13, 2006, the entire contents of which are incorporated herein by reference.

### BACKGROUND

1. Field

One embodiment of the invention relates to an information processing apparatus, which can carry out information processing by virtualization, and an information processing method applied to the apparatus.

2. Description of the Related Art

It is known that in an information processing apparatus, for example a personal computer (PC), a virtual machine (virtual computer) is introduced in addition to a real machine (real computer) which physically exists, thereby reducing the load applied to the real machine and efficiently using resources, such as a memory. Various techniques of this kind have been proposed. For Example, Jpn. Pat. Appln. KOKAI Publication No. 2005-216151 discloses a resource utilizing and managing system, which assigns a virtualized memory resource to a local application across computers connected via a network.

In a computer system including a plurality of computers, each computer generally uses its own hardware resources. However, if the computer is unable to use its own hardware resources for some reason, operations may be obstructed. In this case, it is not easy to effectively use a hardware resource of another computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a configuration of an information processing system according to an embodiment of the present invention;

FIG. 2 is an exemplary flowchart showing an example of operations of a process in a VMMUL until completion of a request from a Guest OS;

FIG. 3 is an exemplary schematic diagram showing the example of operations of the process in a VMMUL until completion of a request from a Guest OS;

FIG. 4 is an exemplary schematic diagram showing HW resource managing agent's operations of collecting HW resource information, and updating HW resource managing information in a VMMUL;

FIG. 5 is an exemplary schematic diagram showing an example of operations of a process, in which a VMMUL adds or delete an HW resource;

FIG. 6 is an exemplary flowchart showing HW resource manager's operations of processing a fail-over;

FIG. 7 is an exemplary schematic diagram showing an example of HW resource manager's operations of processing the fail-over;

FIG. 8 is an exemplary flowchart showing an example of VMMUL's operations of processing a request from a Guest OS;

FIG. 9 is an exemplary schematic diagram showing an example of VMMUL's operations of processing a request from a Guest OS;

FIG. 10 is an exemplary flowchart showing an example of HW resource managing agent's operations of selecting a PC which is to process a request from a Guest OS;

FIG. 11 is an exemplary schematic diagram showing an example of HW resource managing agent's operations of selecting a PC which is to process a request from a Guest OS;

FIG. 12 is an exemplary schematic diagram showing a first example of the network configuration; and

FIG. 13 is an exemplary schematic diagram showing a second example of the network configuration.

### DETAILED DESCRIPTION

Various embodiments according to the invention will be described hereinafter with reference to the accompanying drawings. In general, according to one embodiment of the invention, there is provided an information processing apparatus configured to transmit and receive information to and from another apparatus via a network. The apparatus includes a real processing portion, which has a hardware resource and operates as a real computer, a virtual processing portion, which has a work processing portion that issues a request for process using a hardware resource and which operates as a virtual computer, the virtual processing portion including a hardware resource managing portion having a manager that collectively manages hardware resources of respective information processing apparatuses connected to the network and that is configured to transmit the request for process to one of the information processing apparatuses capable of performing the process in accordance with the request and to acquire a result of process, a first virtual process monitoring portion configured to monitor operations of the virtual processing portion and to transmit information between the real processing portion and the virtual processing portion, and a second virtual process monitoring portion, which is interposed between the first virtual process monitoring portion and the virtual processing portion and configured to receive the request issued from the work processing portion, transfer the request to the hardware resource managing portion if the request satisfies a certain condition, receive the result of process corresponding to the request from the hardware resource managing portion and transfer the result of process to the work processing portion.

1. Basic Configuration

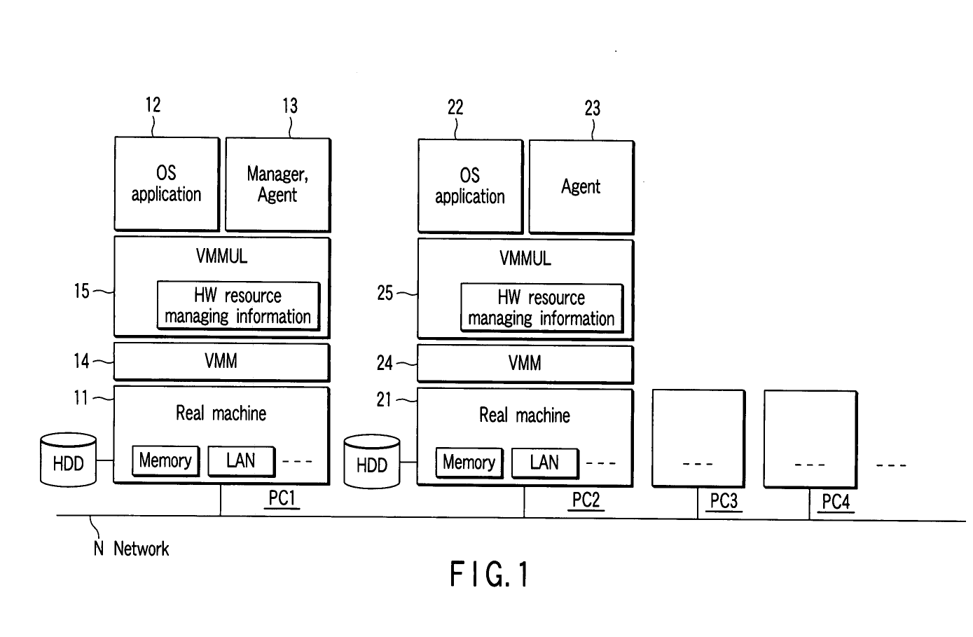

FIG. 1 is a diagram showing a configuration of an information processing system according to an embodiment of the present invention.

The information processing system includes a plurality of information processing apparatuses, which can transmit/receive information to/from another apparatus via a network N. The information processing apparatuses are implemented as personal computers (PCs) 1, 2, . . . .

The PCs 1, 2, . . . respectively includes real machines (real processing portions) 11, 21, business-use virtual machines (business processing portions) 12, 22, . . . , HW resource managing function virtual machines (hardware resource managing portions) 13, 23, . . . , VMMs (Virtual Machine Monitors) (first virtual process monitoring portions) 14, 24, . . . , VMMUL (Virtual Machine Monitor Upper Layers) (second virtual process monitoring portions) 15, 25, . . . , etc.

Each of the real machines 11, 22, . . . has hardware resources, such as an HDD, a memory, a LAN and a CPU, and operates as a real computer (physical PC), which physically exists in actuality.

Each of the business-use virtual machines 12, 22, . . . and the HW resource managing function virtual machines 13, 23, . . . operates as a virtual computer, which virtually exists.

In the business-use virtual machine 12, 22, . . . , an OS and applications that are used in ordinary business are installed. The business-use virtual machine 12, 22, . . . issues a request for process using a hardware resource to the VMM 14, 24 . . . , and receives a process result sent back in reply to the request. In the HW resource managing function virtual machine 13, 23, . . . , a function to collectively manage the hardware resources in the PC 1, 2, . . . (real machine 11, 21, . . . ) is installed. The HW resource managing function virtual machines 13, 23, . . . perform communication with one another via the network N or the like, and can transmit and receive information relating to each of the hardware resources (information indicative of the kind or ID of a resource, information indicative of the state of use (in use/not in use, or the like), etc.)

Each of the VMMs 14, 24, . . . monitors an operation of the business use virtual machine 12, 22, . . . and transmits and receives information between the real machine 11, 21, . . . and the business use virtual machine 12, 22, . . . .

Each of the VMMULs 15, 25, . . . is interposed between the VMM 14, 24, . . . on one hand and the virtual machine (the business-use virtual machine 12 and the HW resource managing function virtual machine 13) and the virtual machine (the business-use virtual machine 22 and the HW resource managing function virtual machine 23), . . . on the other. The VMMUL 15, 25, . . . can be realized without changing the existing OS of each PC. The VMMUL 15, 25, . . . can receive a request for process issued from the business-use virtual machine 12 to the VMM 14, 24, . . . and notify the HW resource managing function virtual machine 13, 23, . . . of the request. Further, it can receive a process result or the like output from the VMM 14, 24, . . . to the business-use virtual machine 12, 22, . . . and notify the HW resource managing function virtual machine 13, 23, . . . of the result. For example, the VMMUL 15 receives a request for process issued from the business-use virtual machine 12. If the request satisfies certain conditions, the VMMUL15 transfers the request to the HW resource managing function virtual machine 13, receives a process result corresponding to the request from the HW resource managing function virtual machine 13, and transfers the result to the business-use virtual machine 12.

Further, each of the VMMULs 15, 25, . . . can hold resource managing information relating to the hardware resources, which are collectively managed by the corresponding HW resource managing function virtual machine 13, 23, . . . . The aforementioned resource managing information relating to the hardware resources are information indicative of the kind or ID of a hardware resource, information indicative of the state of use (in use/not in use, or the like) of the resource, etc.) and information on the HW resource managing function virtual machine of each of the PCs (real machines) connected to the network N. In this case, when the VMMUL 15, 25, . . . receives an I/O request or the like from the Guest OS of the business-use virtual machine, it can select an appropriate PC to execute the process based on the HW resource managing information of its own, and send the request as a packet to the selected PC via the HW resource managing agent. The VMMUL 15, 25, . . . can also receive a request packet sent from a VMMUL of another PC, check the contents of the request, and cause its own PC (real machine) to process the request. Further, the VMMUL 15, 25, . . . can catch addition or deletion of hardware that was made to its own PC (real machine), and notify its own HW resource managing agent of the addition or deletion.

In the above configuration, an HW resource managing function is installed in every HW resource managing function virtual machine 13, 23, . . . . The HW resource managing function is constructed by an HW resource managing agent and an HW resource managing manager. The HW resource managing agent effectively operates (is enabled) in the HW resource managing function of all HW resource managing function virtual machines 13, 23, . . . . On the other hand, the HW resource managing manager operates effectively (is enabled) in the HW resource managing function of only one of the HW resource managing function virtual machines 13, 23, (in the embodiment shown in FIG. 1, the HW resource managing function of only the HW resource managing function virtual machine 13), but is set in an ineffective state (is disabled) in the HW resource managing function of the others.

The HW resource managing agent has a function of collecting HW resource information of the PC (real machine) which the agent itself belongs to, and periodically reporting the information to the HW resource managing manager. The HW resource managing agent also has a function of updating the HW resource managing information which the agent itself manages in the VMMUL. Further, the HW resource managing agent has a function of notifying the HW resource managing manager of the information of new or deleted HW resource information which the VMMUL has caught.

The HW resource managing manager manages the overall HW resource managing information of the corresponding physical PC which the HW resource managing agent has collected. The HW resource managing manager has a function of acquiring the HW resource information collected by the corresponding HW resource managing agent. The HW resource managing manager also has a function of instructing the corresponding HW resource managing agent to update the HW resource managing information. If the HW resource managing manager is stopped because of shutdown of the physical PC or any other reason, the HW resource managing manager installed in another HW resource managing function virtual machine is activated (enabled) by a fail-over function.

2. Processing in the Case Where the HW Resource Managing Function Manages the HW Resource of the Corresponding PC in Advance by the VMMUL

2.1 Processing of the VMMUL Until Completion of a Request from a Guest OS

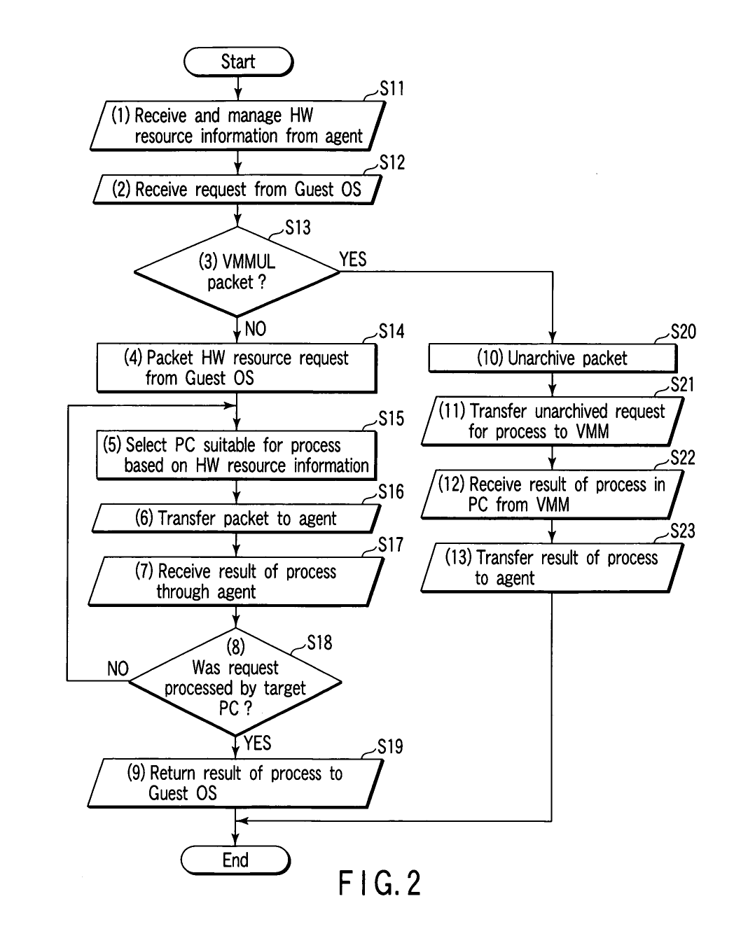

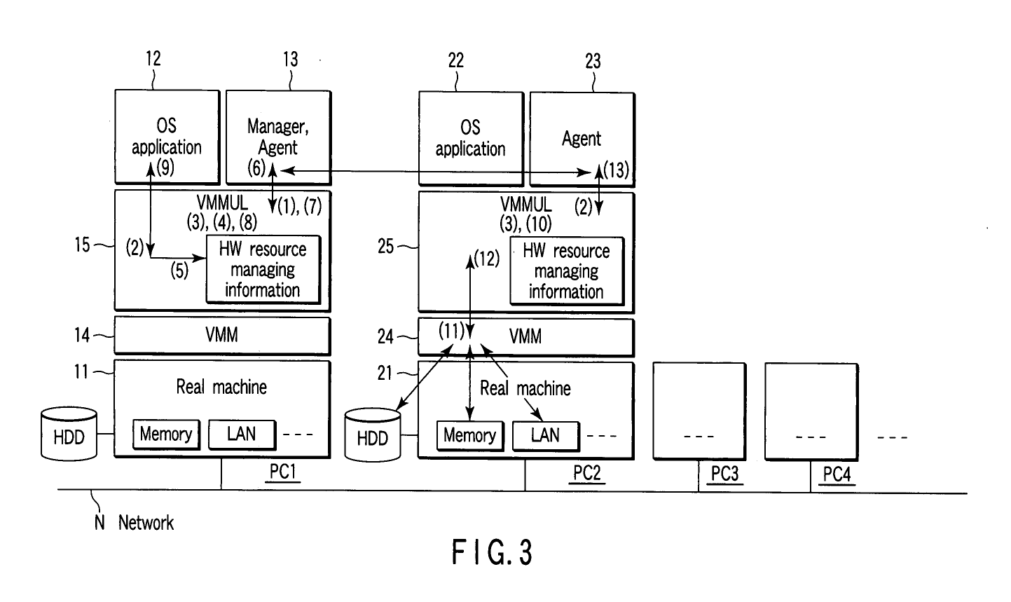

Operations of a process in a VMMUL until completion of a request from a Guest OS will now be described with reference to the flowchart of FIG. 2 and the schematic diagram of FIG. 3.

(1) The VMMUL (for example, the VMMUL 15) periodically receives HW resource managing information on the overall PC from the HW resource managing agent of the HW resource managing function virtual machine, and manages the information in the VMMUL (block S1). Details of collection of the HW resource information will be described later.

(2) The VMMUL receives a request for process from the Guest OS on the business-use virtual machine (for example, the business-use virtual machine 12), such as an I/O (block S12).

(3) The VMMUL checks whether the request for process in the above operation (2) is a packet prepared in the VMMUL of another PC (block S13).

(4) In the case of “No” in the above operation (3) (if the request for process was prepared by the Guest OS of the local PC), the VMMUL packets the request for process (block S14).

(5) The VMMUL selects a PC suitable for processing the request from the Guest OS with reference to the HW resource managing information managed inside the VMMUL (block S15).

(6) The VMMUL transfers the packet prepared in the above operation (4) to the HW resource managing agent on the local PC (block S16). As a result, the HW resource managing agent transfers the packet to the HW resource managing agent on the PC which carries out the process. The subsequent processes on the side which receives the packet are those in the operations (10) to (13) described below.

(7) The VMMUL receives a result of the process through the HW resource managing agent from the PC which carried out the process (block S17).

(8) The VMMUL checks the result of the process, and determines whether the request was properly processed or not (block S18). In the case of “No” (if the request was not processed by the target PC), the process returns to the selection of a PC in the above operation (5).

(9) In the case of “Yes” in the above operation (8) (if the request was processed by the target PC), the VMMUL sends the result of the process back to the Guest OS, which made the request for process (block S19).

(10) In the case of “Yes” in the above operation (3) (if the packet was prepared by the VMMUL of another PC), the VMMUL unarchives the packet (block S20).

(11) The VMMUL transfers the unarchived request for process to the VMM (block S21). Then, the VMM causes the PC to process the content of the request.

(12) The VMMUL receives the result of the process in the PC on the way from the VMM (block S22).

(13) The VMMUL transfers the result of the process to the HW resource managing agent (block S22). Then, the HW resource managing agent transfers the result of the process to the HW resource managing agent of the PC which made the request. On the side which receives the result of the process, the same operations as the operation (7) and the subsequent operations are carried out.

2.2 Processing of Collecting HW Resource Information and Updating the HW Resource Managing Information in the VMMUL by the HW Resource Managing Agent

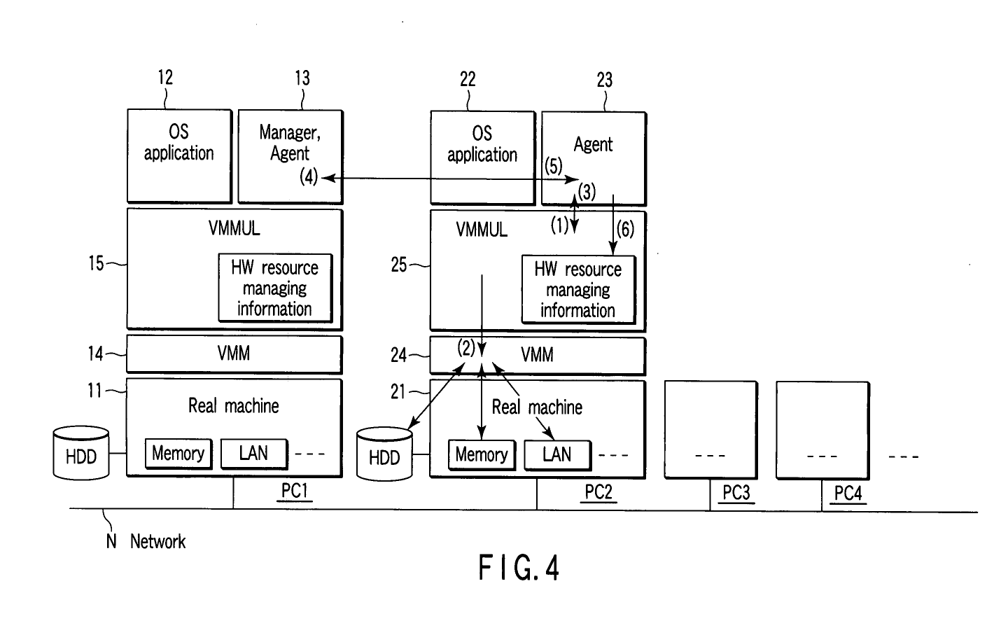

Operations of collecting HW resource information and updating the HW resource managing information in the VMMUL by the HW resource managing agent will now be described with reference to the schematic diagram of FIG. 4.

(1) The HW resource managing agent of each PC requests HW resource information from the VMMUL (for example, the VMMUL 25).

(2) The VMMUL acquires HW information managed by the VMM (for example, the VMM 24).

(3) The VMMUL sends the HW resource information back to the HW resource managing agent.

(4) The HW resource managing agent reports the collected HW resource information to the HW resource managing manager (for example, the HW resource managing manager in the HW resource managing function virtual machine 13).

(5) The HW resource managing manager integrates the HW resource managing information received from the HW resource managing agent of each PC, and sends the HW resource managing information on the overall network to the HW resource managing agents.

(6) Each of the HW resource managing agents updates the HW resource managing information managed by the VMMUL.

2.3 Processing of Adding or Deleting the HW Resource by the VMMUL

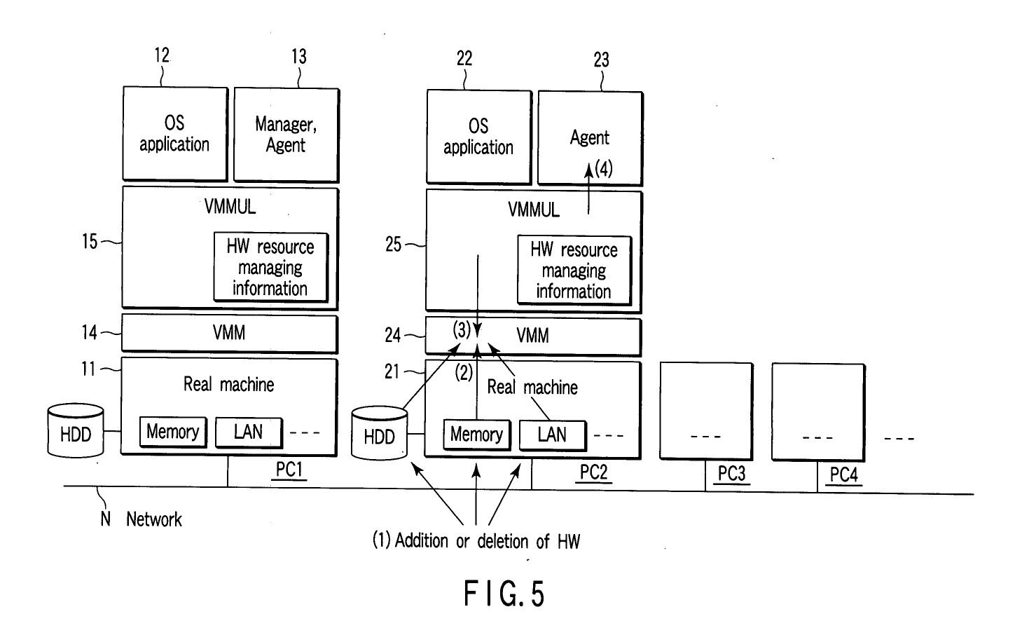

Operations of adding or deleting the HW resource by the VMMUL will be described with reference to the schematic diagram of FIG. 5.

(1) Hardware (for example, hardware provided in the real machine 21) is added or deleted.

(2) The VMM (for example, the VMM 24) is notified of the event of adding or deleting the hardware.

(3) The VMMUL (for example, the VMMUL 25) detects the event of adding or deleting the hardware.

(4) The VMMUL notifies the HW resource managing agent of the event of adding or deleting the hardware.

(5) Thereafter, on the side which receives the notification, the above operations (1) to (6) of the processing 2.2 are carried out.

2.4 Processing of Failover of the HW Resource Managing Manager

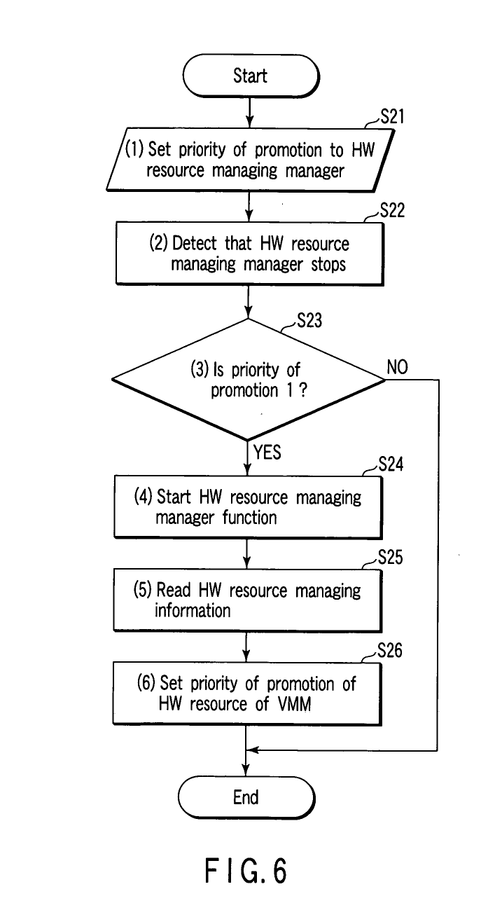

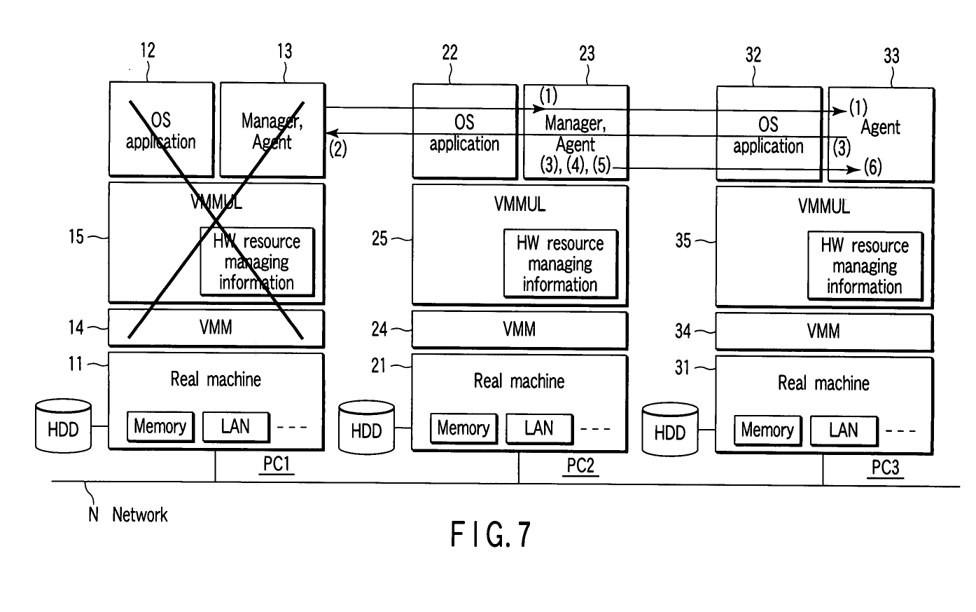

Operations of failover processing of the HW resource managing manager will be described with reference to the flowchart of FIG. 6 and the schematic diagram of FIG. 7.

(1) The HW resource managing manager (for example, the HW resource managing manager in the HW resource managing function virtual machine 13) sets the priority of promoting each HW resource managing agent to the HW resource managing manager (block S21).

(2) Each HW resource managing agent detects that the HW resource managing manager is stopped (block S22).

(3) The HW resource managing agent checks whether its own priority of promoting to the HW resource managing manager is 1 (block S23).

(4) In the case of “Yes” in the above operation (3) (if the priority of promoting to the HW resource managing manager is 1), the HW resource managing manager installed in the same HW resource managing function virtual machine is activated (promoted) (block S24). In the case of “No”, the processing is ended.

(5) The promoted HW resource managing manager (for example, the HW resource managing manager in the HW resource managing function virtual machine 23) reads the HW resource managing information which the HW resource managing agent of the same HW resource managing function virtual machine received (block S25).

(6) The promoted HW resource managing manager resets the priority of promoting each HW resource managing agent to the HW resource managing manager (block S26).

3. Processing of a VMMUL in the Case Where the HW Resource Managing Function Checks the HW Resource and Selects a PC Upon Every Request from a Guest OS

3.1 Operations of Processing a Request from the GUEST OS by the VMMUL

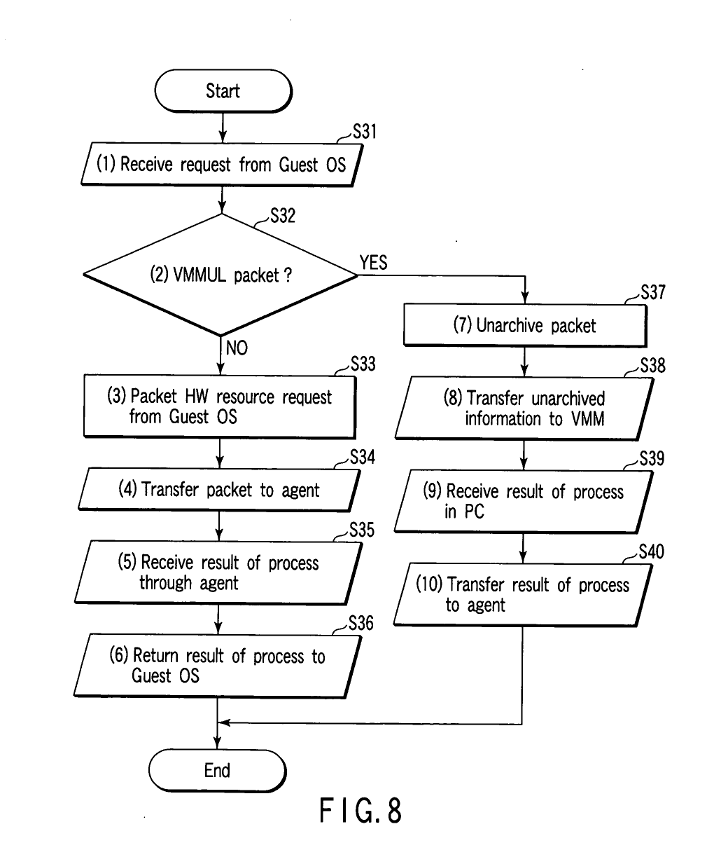

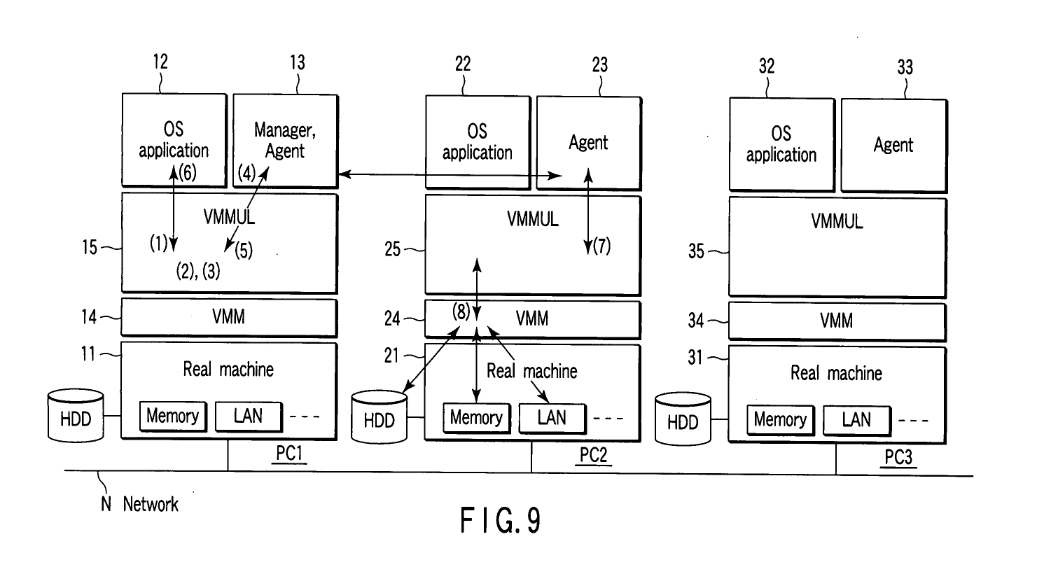

Operations of processing a request from a Guest OS by the VMMUL will be described with reference to the flowchart of FIG. 8 and the schematic diagram of FIG. 9.

(1) The VMMUL (for example, the VMMUL 15) receives a request for process from a Guest OS on a virtual machine, such as an I/O (block S31).

(2) The VMMUL checks whether the request for process in the above operation (1) is a packet prepared in the VMMUL of another PC (block S32).

(3) In the case of “No” in the above operation (2) (if the request for process was prepared by the Guest OS of the local PC), the VMMUL packets the request for process (block S33).

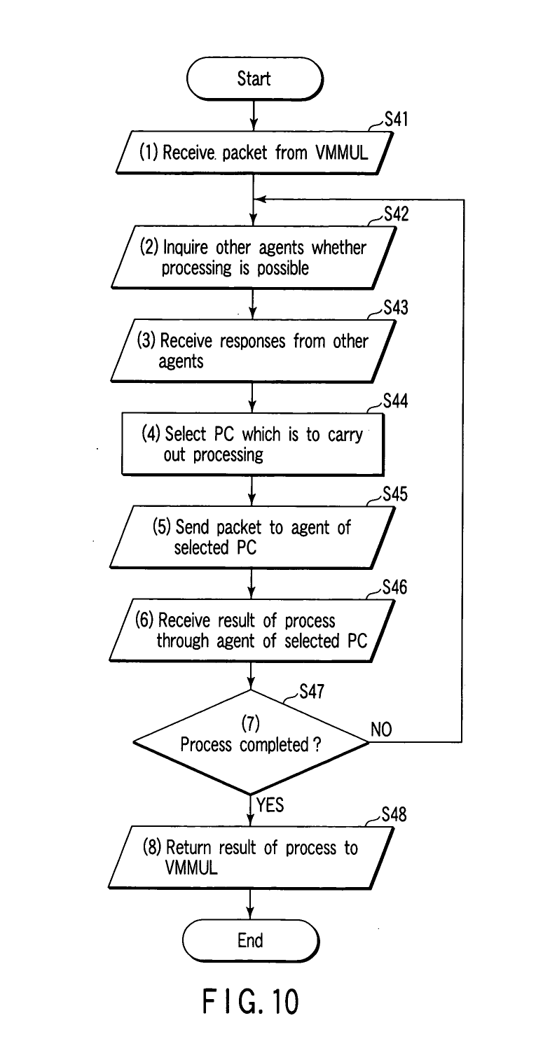

(4) The VMMUL transfers the packet prepared in the above operation (3) to the HW resource managing agent on the local PC (block S34). Then, the HW resource managing agent transfers the packet to the HW resource managing agent on the PC which carries out the process. The subsequent processes on the side which receives the packet are those in the operations (7) to (10) described later. Selection of the PC which is to carry out the process is described later with reference to FIG. 10 etc.

(5) The VMMUL receives a result of the process through the HW resource managing agent from the PC which carried out the process (block S35).

(6) The VMMUL sends the result of the process back to the Guest OS, which made the request for the process (block S36).

(7) In the case of “Yes” in the above operation (2) (if the packet was prepared by the VMMUL of another PC), the VMMUL unarchives the packet (block S37).

(8) The VMMUL transfers the unarchived request for process to the VMM (block S38). Then, the VMM causes the PC to process the contents of the request.

(9) The VMMUL receives the result of the process in the PC on the way from the VMM (block S39).

(10) The VMMUL transfers the result of the process to the HW resource managing agent (block S40). Then, the HW resource managing agent transfers the result of the process to the HW resource managing agent of the PC which made the request. Thereafter, on the side which receives the result of the process, the same operations as the operation (5) and the subsequent operations are carried out.

3.2 HW Resource Managing Agent's Operations of Selecting a PC Which Carries Out a Request from a Guest OS

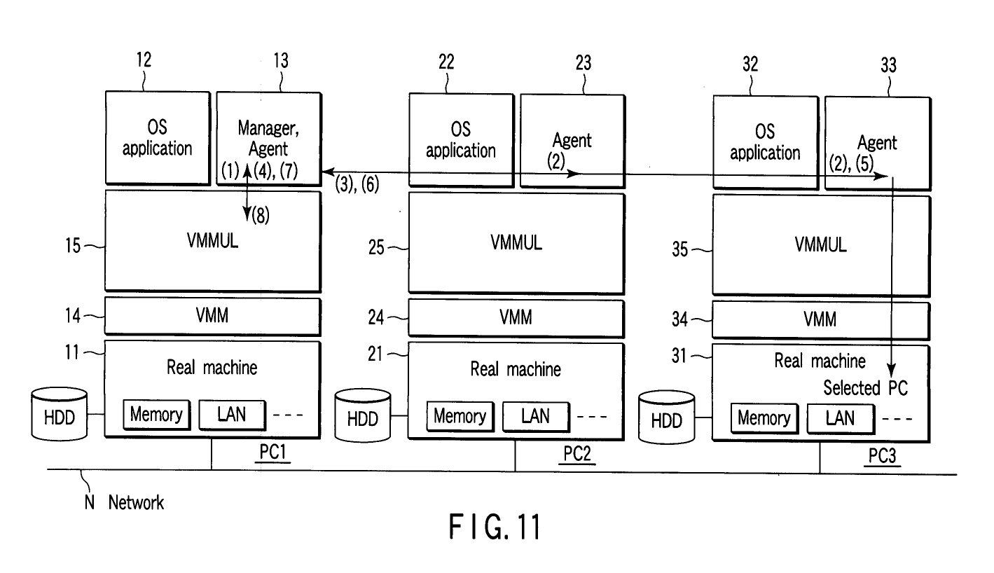

HW resource managing agent's operations of selecting a PC which is to deal with a request from a Guest OS will be described with reference to the flowchart of FIG. 10 and the schematic diagram of FIG. 11.

(1) The HW resource managing agent (for example, the HW resource managing agent in the HW resource managing function virtual machine 13) receives a packet of request for process from the VMMUL (for example, the VMMUL 15) (block S41).

(2) The HW resource managing agent checks the contents of the packet and inquires other HW resource managing agents whether they can deal with the packet (block S42).

(3) The HW resource managing agent receives responses from the other agents (block S43).

(4) The HW resource managing agent selects a PC which first sent a response that it can deal with the packet in the above operation (3) (block S44).

(5) The HW resource managing agent sends the packet to the agent of the PC selected in the above operation (4) (block S45).

(6) The HW resource managing agent receives a request of the process from the selected PC (block S46).

(7) The HW resource managing agents checks whether the process has been completed (block 47).

(8) In the case of “Yes” (if the process has been completed) in the operation (7), the HW resource managing agent send the result of the process back to the VMMUL (block S48). In the case of “No” (if the process has not completed), the above operations (2) to (7) are carried out.

4. Network Configuration

4.1 First Example of Network Configuration

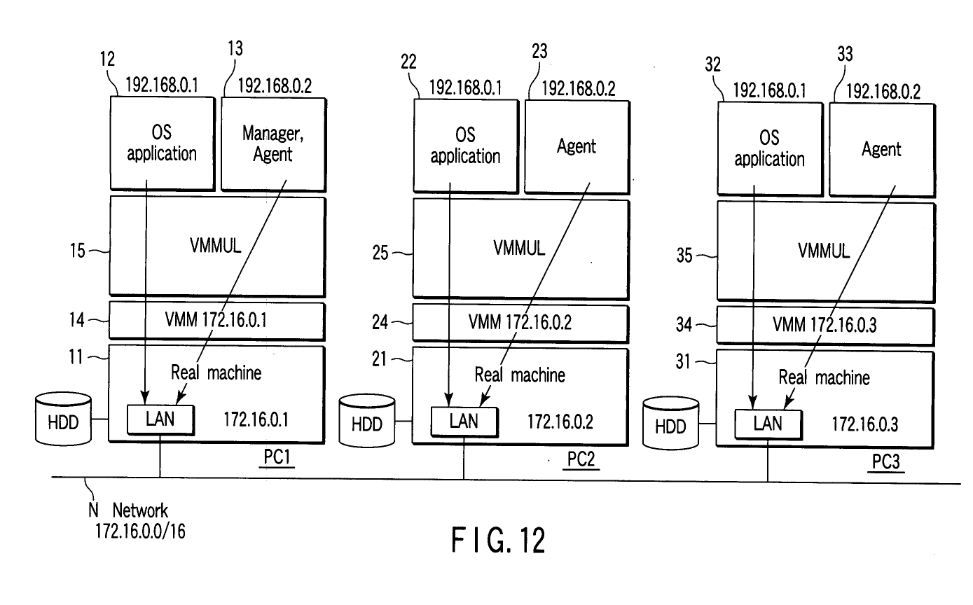

A first example of the network configuration will be described with reference to the schematic diagram of FIG. 12.

The network N used in the above description is not changed. However, the two kinds of virtual machines (the business-use virtual machine and the HW resource managing function virtual machine) of each PC use one network card (for example, a LAN card) in common in the corresponding real machine. Each virtual machine has a private IP address, which is converted to a global IP address to perform communication.

4.2 Second Example of Network Configuration

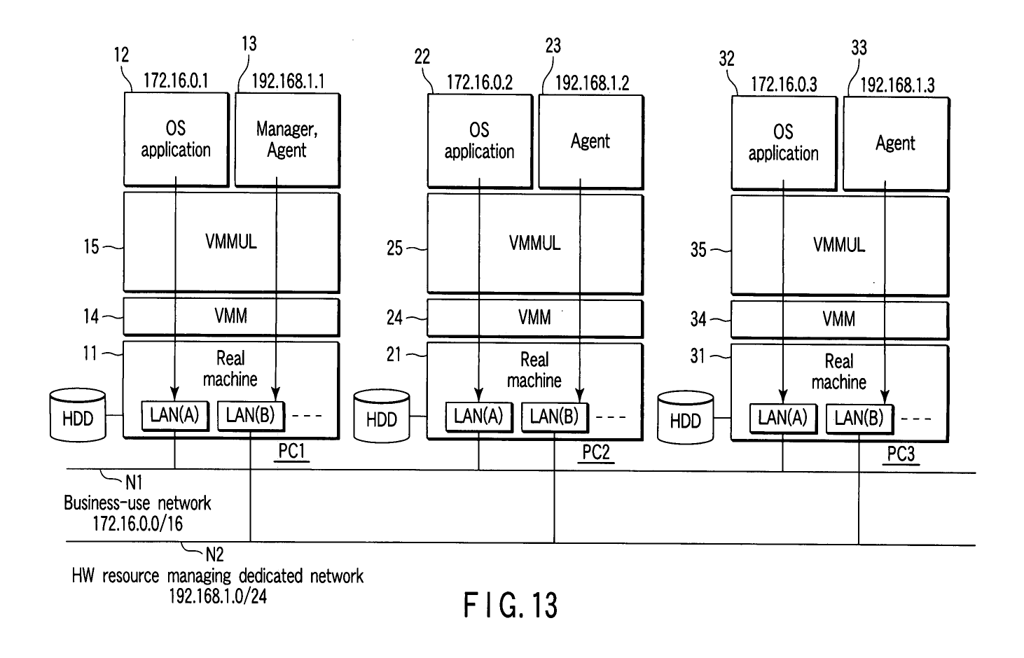

A Second example of the network configuration will be described with reference to the schematic diagram of FIG. 13.

Each PC has two network cards (for example, LAN cards). Two separate networks of a business-use network N1 and a HW resource managing dedicated network N2 are used instead of the network N. The business-use virtual machines use the business-use network N1, and the HW resource managing function virtual machines use the HW resource managing dedicated network N2 only for the purpose of managing the HW resources. Thus, since the information on the hardware resource and the information on a request for process and result of the process are transmitted and received through separate networks, the processing of data transmission in the entire system is accelerated.

As has been described in detail, according to the above embodiment, the following advantages can be obtained.

1. The virtual machine of each PC can efficiently utilize the resources of the entire system, not only the hardware resources of its own but also the hardware resources of the other PCs. Therefore, the efficiency of the processing in business can be improved.

2. Failover processing is carried out easily because of the functions of the agents or the like in the HW resource managing function virtual machines.

3. Since it is unnecessary to add any change to a Guest OS on a virtual machine, efficient work can be realized at a low cost.

The process steps in the embodiment of the present invention described above can stored as a computer program in a computer-readable memory medium (for example, a magnetic disk, optical disk or semiconductor memory), and read out and carried out by a processor when necessary. Such a computer program can be distributed from one computer to another via a communication medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus configured to transmit and receive information to and from another apparatus via a network, the apparatus comprising:
a real processing portion, which has a hardware resource and operates as a real computer;
a virtual processing portion, which has a work processing portion that issues a request for process using a hardware resource and which operates as a virtual computer, the virtual processing portion including a hardware resource managing portion having a manager that collectively manages hardware resources of respective information processing apparatuses connected to the network and that is configured to transmit the request for process to one of the information processing apparatuses capable of performing the process in accordance with the request and to acquire a result of process;
a first virtual process monitoring portion configured to monitor operations of the virtual processing portion and to transmit information between the real processing portion and the virtual processing portion; and
a second virtual process monitoring portion, which is interposed between the first virtual process monitoring portion and the virtual processing portion and configured to receive the request issued from the work processing portion, transfer the request to the hardware resource managing portion if the request satisfies a certain condition, receive the result of process corresponding to the request from the hardware resource managing portion and transfer the result of process to the work processing portion.

2. The information processing apparatus according to claim 1, wherein the second virtual process monitoring portion has resource managing information on the hardware resources collectively managed by the hardware resource managing portion and selects one of the information processing apparatuses which is to process the request received from the work processing portion based on the resource managing information.

3. The information processing apparatus according to claim 1, wherein a function of the manager can be taken over to another information processing apparatus.

4. An information processing method applied to a system including a plurality of information processing apparatuses, each being configured to transmit and receive information to and from another apparatus via a network and each comprising: a real processing portion, which has a hardware resource and operates as a real computer; a first virtual processing portion, which has a work processing portion that issues a request for process using a hardware resource and which operates as a virtual computer; and a first virtual process monitoring portion configured to monitor operations of the virtual processing portion and to transmit information between the real processing portion and the virtual processing portion, the method comprising:
collectively managing hardware resources of the plurality of information processing apparatuses connected to the network by means of the virtual processing portion of a first information processing apparatus;
in the first information processing apparatus, when a request is issued from the work processing portion, receiving the request by means of a second virtual process monitoring portion interposed between the first virtual process monitoring portion and the virtual processing portion, and transferring the request through the virtual processing portion to a second information processing apparatus capable of performing a process corresponding to the request, if the request satisfies a certain condition;
in the second information processing apparatus, receiving the request by means of the second virtual process monitoring portion through the virtual processing portion, and causing the real processing portion to execute the process according to the request through the first virtual process monitoring portion;
in the second information processing apparatus, receiving a result of process in the real processing portion output from the first virtual process monitoring portion by means of the second virtual process monitoring portion, and transmitting the received result of process to the first information processing apparatus through the virtual processing portion; and
in the first information processing apparatus, receiving the transmitted result of process by means of the second virtual process monitoring portion through the virtual processing portion, and transferring the received result of process to the work processing portion.

5. The information processing method according to claim 4, wherein the second virtual process monitoring portion in the first information processing apparatus selects one of the information processing apparatuses which is to process the received request based on the resource managing information on the collectively managed hardware resources.

6. The information processing method according to claim 4, further comprising taking over a function of the management from the virtual processing portion of the first information processing apparatus to the virtual processing portion of the second information processing apparatus, when the first information processing apparatus is in a halt condition.

7. The information processing method according to claim 4, wherein information on each hardware resource and information on each request for process are transmitted through separate networks.

8. A storage medium storing computer-executable program code executed by a processor in an information processing apparatus configured to transmit and receive information to and from another apparatus via a network, and including a real processing portion, which has a hardware resource and operates as a real computer, a virtual processing portion, which has a work processing portion that issues a request for process using a hardware resource and which operates as a virtual computer, and a first virtual process monitoring portion configured to monitor operations of the virtual processing portion and to transmit information between the real processing portion and the virtual processing portion, the program code comprising:
means for causing a computer to configure a hardware resource managing portion in the virtual processing portion to have a manager that collectively manages hardware resources of respective information processing apparatuses connected to the network and that is configured to transmit the request for process to one of the information processing apparatuses capable of performing the process in accordance with the request and to acquire a result of process; and
means for causing a computer to configure a second virtual process monitoring portion, which is interposed between the first virtual process monitoring portion and the virtual processing portion and which receives the request issued from the work processing portion, transfers the request to the hardware resource managing portion if the request satisfies a certain condition, receives the result of process corresponding to the request from the hardware resource managing portion and transfers the result of process to the work processing portion.

9. The storage medium according to claim 8, wherein the program code further comprises means for causing a computer to configure the second virtual process monitoring portion to select one of the information processing apparatuses which is to process the request received from the work processing portion based on resource managing information on the hardware resources collectively managed by the hardware resource managing portion.

10. The storage medium according to claim 9, wherein the program code further comprises means for causing a computer to allow a function of the manager to be taken over to another information processing apparatus.
